(19) United States
(12) Patent Application Publication
(10) Pub. No.: US 2025/0382441 A1
(43) Pub. Date: Dec. 18, 2025

(54) HIGH VOLTAGE COMPONENTS

(71) Applicant: ENVALIOR DEUTSCHLAND GMBH, Dusseldorf (DE)

(72) Inventors: Jochen Endtner, Cologne (DE); Dirk Schmitz, Weeze (DE); Matthias Bienmueller, Krefeld (DE)

(21) Appl. No.: 19/318,928

(22) Filed: Sep. 4, 2025

Related U.S. Application Data
(62) Division of application No. 17/439,627, filed on Sep. 15, 2021, now Pat. No. 12,448,497.

(30) Foreign Application Priority Data
Mar. 15, 2019 (EP) 19163035.9

(51) Int. Cl. C08K 5/3465; B29B 9/06; B29K 77/00; B29K 105/00

(52) U.S. Cl. CPC C08K 5/3465; B29B 9/06; B29K 2077/00; B29K 2105/0026; B29K 2105/0044; B29K 2995/0017

(57) ABSTRACT

Polymer compositions that are usefully employed in high-voltage components, in particular for electromobility, are based on at least one polyamide and 10,10′-oxybis-12H-phthaloperin-12-one, and to the use of 10,10′-oxybis-12H-phthaloperin-12-one for marking polyamide-based articles of manufacture as high-voltage components.

### CROSS-REFERENCE TO RELATED APPLICATIONS

This application is a divisional of U.S. application Ser. No. 17/439,627 filed on Sep. 15, 2021 (now U.S. Pat. No. XX,XXX,XXX), which in turn is the U.S. national phase of International Application No. PCT/EP2020/056700 filed on Mar. 12, 2020, which designated the U.S. and claims priority to European Application No. 19163035.9 filed on Mar. 15, 2019, the entire contents of each being expressly incorporated hereinto by reference.

### FIELD

The present invention relates to high-voltage components, in particular for electromobility, containing polymer compositions based on at least one polyamide and 10,10′-oxybis-12H-phthaloperin-12-one, and to the use of 10,10′-oxybis-12H-phthaloperin-12-one for marking polyamide-based articles of manufacture as high-voltage components.

### BACKGROUND

Technical thermoplastics such as polyamides are important materials, particularly also in the field of components for motor vehicles, due to their good mechanical stability, their chemicals resistance, very good electrical properties and good workability.

Polyamides have formed an important constituent for manufacturing demanding motor vehicle components for many years. While the internal combustion engine has been the dominant drive concept for many years, new requirements with regard to choice of materials also arise in the course of the search for alternative drive concepts. Playing a substantial role here is electromobility, where the internal combustion engine has been partly (hybrid vehicle [HEV, PHEV, BEV Rex]) or completely (electromobile [BEV. FCEV]) replaced by one or more electric motors which typically obtain their electric energy from batteries or fuel cells. While conventional vehicles having internal combustion engines as their sole means of propulsion (ICE [Internal Combustion Engine]) typically make do with a 12V onboard voltage system, hybrid and electric vehicles having electric motors as drive unit require significantly higher voltages. This poses a serious additional risk potential for the direct region and the immediate surroundings of such high voltage parts which plays an increasingly important role in technical specifications or else in standards. Of importance here is the unambiguous marking of these dangerous regions in order thus to avoid unintentional contacts with people (driver, mechanic etc.), unambiguous colour marking of such high-voltage assemblies in turn being particularly important.

The Advanced Vehicle Team of the Idaho National Laboratory for HEV (Hybrid Electric Vehicle) has published a technical specification which recommends for all apparatuses exposed to high voltage of not less than 60 V inter alia a clear marking as “HIGH VOLTAGE” and in this connection also refers to the colour orange for marking.

However, due to the high processing temperatures of in some cases >300° C. during compounding and during injection moulding the choice of suitable colourants for the colour orange is very limited especially for technical thermoplastics.

WO 2005/084955 A1 discloses laser-weldable compositions, inter alia based on polyamide containing a dye, wherein, for example, Solvent Orange 60 can be used as the dye.

EP 0 827 986 A2 relates to bridged perinones, quinophthalones and perinone-quinophthalones, to a process for producing them and to their use for mass colouration of plastics. Polystyrene, styrene copolymers, polycarbonates and polymethacrylate are listed as preferred plastics, polystyrene, polyethylene and polypropylene being particularly preferred. Example 16 specifically mentions 10,10′-oxy-bis-12H-phthaloperin-12-one.

EP 0 041 274 B1 describes fluorescing compositions capable of altering the wavelengths of the light, moulded articles based on such compositions as light wave-transforming elements and apparatuses for transforming optical energy into electrical energy using such an element. The examples of EP 0 041 274 B1 employ inter alia 12H-phthaloperin-12-one in polyethylene terephthalate (PET). Furthermore, use inter alia in polyamides is suggested in EP 0 041 274 B1.

12H-Phthaloperin-12-one [CAS No. 6925-69-5], known as Solvent Orange 60, is obtainable for example as Macrolex® Orange 3G from Lanxess Deutschland GmbH, Cologne. However a disadvantage is that under extreme demands, in particular under the demands seen in electromobility, Solvent Orange 60 has a propensity for migrating out of the plastic matrix which results in a reduction in colour intensity at elevated temperatures. The Solvent Orange 60 migrates to the surface of the plastic (blooming). From there it may be rubbed off, washed off or dissolved, may volatilize (fogging) or migrate into other materials (for example adjacent plastic or rubber parts) (bleeding). The concentration of the Solvent Orange 60 in the original plastic is reduced, thus causing a reduction in colour intensity. The migrated Solvent Orange 60 also has the disadvantage that it may be transported to adjacent component parts by mechanical or physical processes to cause performance impairment there. Examples include elevated electrical resistance in a switch contact which may result on the surface of electrical contacts through deposition of Solvent Orange 60. In the field of electrical components migration of ingredients from plastics is therefore generally undesired since it can affect the properties of the plastics and of spatially adjacent parts, with the result that the performance of the electrical component is no longer ensured in some cases.

Proceeding from the teaching of EP 0 041 274 B1 the present invention accordingly had for its object to provide orange polymer compositions based on polyamide for high-voltage components, in particular for high-voltage components in electric vehicles, which compositions are less susceptible to migration, in particular bleeding, compared to the solution in EP 0 041 274 B1 based on 12H-phthaloperin-12-one. Inventive orange polyamide-based moulding materials shall ideally also exhibit improved lightfastness and improved thermal stability compared to the prior art to the effect that under UV light and under thermal stress the original colour achieved immediately after injection moulding is retained for longer than in the case of 12H-phthaloperin-12-one. Orange polyamide-based moulding materials according to the invention shall ideally also be laser transparent/laser transmitting for light wavelengths in the range from 800 nm to 1100 nm in order thus to allow the condition for through-transmission laser welding to another assembly absorbent in the recited wavelength range.

### SUMMARY

It has now been found that, surprisingly, high-voltage components, in particular high-voltage components for electromobility, containing thermoplastic polymer compositions based on polyamide and 10,10′-oxy-bis-12H-phthaloperin-12-one [CAS No. 203576-97-0] of formula (I) meet the specified requirements.

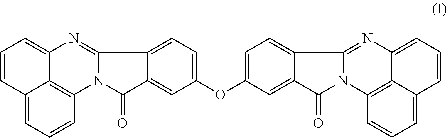 [SMILES: O=C1c2cc(Oc3ccc4c(c3)C(=O)N3C4=Nc4cccc5cccc3c45)ccc2C2=Nc3cccc4cccc(c34)N12]

### BLEEDING

In the context of the present invention bleeding was determined as follows:

Plastic sheets having dimensions of 60·40·2 mm³ are initially fabricated from a colourant- containing polyamide composition to be investigated. A plasticized PVC film having dimensions of 30·20·2 mm³ is subsequently placed between two of the initially fabricated plastic sheets and the entirety of all sheets is stored at 80° C. for 12 hours in a hot air drying cabinet. Subsequent evaluation of the colourant that has migrated from the two plastic sheets into the plasticized PVC is then carried out visually according to the grey scale of ISO 105-A02, wherein ‘5’ means that the PVC film shows no colour change (no visually discernible colourant transfer from the polyamide plastic sheets to the PVC film) and ‘1’ means that the PVC film shows a strong colour change (strong visually discernible colourant, transfer from the polyamide plastic sheets to the PVC film).

### LIGHTFASTNESS

The measure of lightfastness used in the context of the present invention is the discolouration after UV storage of above-described plastic sheets based on the colourant-containing polyamide composition to be investigated with a UV light of the type Suntest CPS+, air-cooled Atlas Xenon lamp, 1500 Watt, 45-130 klx, wavelength 300-800 nm and Window Glass Filter 250-267 W/m² from Atlas Material Testing Technology GmbH, Linsengericht, Germany, and an irradiation time of 96 h. Discolouration was evaluated visually based on the blue wool scale according to DIN EN ISO 105-B02, wherein ‘8’ represents exceptional lightfastness (little colour change) and ‘1’ represents very low lightfastness (strong colour change).

### DETAILED DESCRIPTION

The invention provides polymer compositions containing at least one polyamide and 10,10′-oxy-bis-12H-phthaloperin-12-one.

Preference is given to compositions in which nylon 6 or nylon 6,6 is used as polyamide.

Preference is further given to polymer compositions in which 0.01 to 5 parts by mass, particularly preferably 0.01 to 3 parts by mass, of 10,10′-oxy-bis-12H-phthaloperin-12-one are used per 100 parts by mass of polyamide.

However, the invention also provides high-voltage components, in particular high-voltage components for electromobility, based on polymer compositions containing at least one polyamide and 10,10′-oxy-bis-12H-phthaloperin-12-one.

However, the invention also provides high-voltage components, in particular high-voltage components for electromobility, based on polymer compositions containing at least one polyamide and 10,10′-oxy-bis-12H-phthaloperin-12-one, in which nylon 6 or nylon 6,6 are used as polyamide.

However, the invention also provides high-voltage components, in particular high-voltage components for electromobility, based on polymer compositions containing 0.01 to 5 parts by mass, particularly preferably 0.01 to 3 parts by mass, of 10,10′-oxy-bis-12H-phthaloperin-12-one per 100 parts by mass of at least one polyamide.

However, the invention also provides laser-transparent high-voltage components, in particular high-voltage components for electromobility, based on polymer compositions containing 0.01 to 3 parts by mass of 10,10′-oxy-bis-12H-phthaloperin-12-one per 100 parts by mass of at least one polyamide with the proviso that laser-absorbent components are eschewed.

The present invention also relates however to the use of 10,10′-oxy-bis-12H-phthaloperin-12-one for producing polyamide-based polymer compositions, preferably polyamide-based high-voltage components, in particular polyamide-based high-voltage components for electromobility. The invention finally relates to the use of 10,10′-oxy-bis-12H-phthaloperin-12-one for marking polyamide-based articles of manufacture as high-voltage components.

The polymer compositions according to the invention are formulated for further use by mixing the components A) and B) to be used as reactants in at least one mixing apparatus. This affords as intermediates moulding materials based on the compositions according to the invention. These moulding materials may either consist exclusively of the components

A) and B) or else may contain in addition to the components A) and B) at least one further component.

For clarity, it should be noted that the scope of the present invention encompasses all the definitions and parameters, mentioned hereinafter in general terms or specified within areas of preference, in any desired combinations. This likewise relates to the combination of the stated amounts for the individual components in relation to the claimed processes and uses. The standards recited in the context of this application relate to the edition current on the application date of the present invention.

### High voltage

In Regulation no. 100 of the United Nations Economic Commission for Europe (UNECE)-Uniform provisions concerning the approval of vehicles with regard to the specific requirements for the electric power train [2015/505] paragraph 2.17 describes the term “high voltage” as a voltage for which an electrical component or a circuit is configured whose effective value of operating voltage is >60 V and ≤1 500 V (direct current) or >30 V and ≤1 000 V (alternating current).

This classification of “high voltage” corresponds to voltage class B of ISO6469-3:2018 (“Electrically propelled road vehicles—Safety specifications—Part 3: Electrical safety”). Section 5.2 thereof also includes marking requirements for electrical components of voltage class B through appropriate hazard symbols or the colour ‘orange’.

### High-Voltage Components and High-Voltage Components for Electromobility

According to the invention the term high-voltage component is to be understood as meaning components or articles of manufacture subjected to an operating voltage according to section 2.17 of the abovementioned Regulation no. 100 of the United Nations Economic Commission for Europe (UNECE). According to the invention high-voltage components for electromobility is preferably to be understood as meaning components in electric vehicles subjected to an operating voltage of not less than 30 V (direct current) or not less than 20 V (alternating current), particularly preferably—as per voltage class B of ISO6469-3:2018—an operating voltage of greater than 60 V (direct current) or more than 30 V (alternating current).

According to the invention high-voltage components for electromobility include not only such components in direct contact with the voltage-conducting parts but also those that directly adjacent thereto or in spatial proximity thereto act as a touch guard, a warning marking or a shielding means, wherein components in direct contact with the voltage-conducting parts are preferred according to the invention.

High-voltage components for electromobility according to the invention are preferably coloured orange, wherein shades corresponding in the RAL colour system to colour numbers RAL2003, RAL2004, RAL2007, RAL2008, RAL2009, RAL2010 and RAL2011 are particularly preferred and the shades corresponding in the RAL colour system to the colour numbers RAL2003, RAL2004, RAL2008 and RAL2009 are very particularly preferred and RAL 2003 is especially preferred.

“Similar shades” likewise allowable according to the invention are shades whose colour difference in the L*a*b* system has a ΔE of <20, preferably a ΔE <10, particularly preferably ΔE <5, to the L*a*b* value of a particular RAL shade defined in the RAL colour chart.

In one embodiment of the present invention the inventive high-voltage components for electromobility are by addition of further components configured such that they are absorbent for laser light having a wavelength in the range from 800 nm to 1100 nm so that combination of one laser-transparent configuration and one laser-absorbent configuration confers laser weldability.

### Orange

In the context of the present invention orange is to be understood as meaning a colour which in the RAL colour system has a colour number beginning with “2” in the RAL colour chart. In particular, at the filing date of the present invention a distinction is made between the orange shades according to Table 1:

TABLE 1

| | | L* | a* | b* |
|---|---|---|---|---|
| RAL 2000 | Yellow orange | 58.20 | 37.30 | 68.68 |
| RAL 2001 | Red orange | 49.41 | 39.79 | 35.29 |
| RAL 2002 | Blood orange | 47.74 | 47.87 | 33.73 |
| RAL 2003 | Pastel orange | 66.02 | 41.22 | 52.36 |
| RAL 2004 | Pure orange | 56.89 | 50.34 | 49.81 |
| RAL 2005 | Luminous orange | 72.27 | 87.78 | 82.31 |
| RAL 2007 | Luminous bright orange | 76.86 | 47.87 | 97.63 |
| RAL 2008 | Bright red orange | 60.33 | 46.91 | 60.52 |
| RAL 2009 | Traffic orange | 55.83 | 47.79 | 48.83 |
| RAL 2010 | Signal orange | 55.39 | 40.10 | 42.42 |
| RAL 2011 | Deep orange | 59.24 | 40.86 | 64.50 |
| RAL 2012 | Salmon orange | 57.75 | 40.28 | 30.66 |
| RAL 2013 | Pearl orange | 40.73 | 32.14 | 34.92 |

Table 1 shows the apparatus-independent CIE L*a*b* colour values for the respective RAL value: L* stands for luminance, a*=D65 and b*=10°. The colour model is standardized in EN ISO 11664-4 “Colorimetry—Part 4: CIE 1976 L*a*b* Colour space”. For L*a*b* colour space (also: CIELAB). Each colour in the colour space is defined by a colour point having the Cartesian coordinates {L*, a*, b*}. The a*b *-coordinate plane was constructed using opponent colour theory. Green and red are at opposite ends of the a* axis from one another and the b *-axis runs from blue to yellow. Complementary shades are respectively by 180° opposite one another and the point centrally between them (the coordinate origin a*=0, b*=0) is grey.

The L *-axis describes the brightness (luminance) of the colour with values from 0 to 100. In the representation it is arranged perpendicularly to the a*b *-plane at zero point. It may also be referred to as the neutral grey axis since all non-coloured shades (grey scale) are contained between the endpoints black (L*=0) and white (L*=100). The a *-axis describes the green or red fraction of a colour, wherein negative values represent green and positive values represent red. The b*-axis describes the blue or yellow fraction of a colour, wherein negative values represent blue and positive values represent yellow.

The a *-values span from approximately −170 to +100 and the b *-values from −100 to +150, wherein the maximum values are achieved only at intermediate brightness of certain shades. The CIELAB colour space has its greatest extent in the intermediate brightness range though this differs in height and size depending on the colour range.

In the context of the present invention preference is given to polymer compositions and high-voltage components producible therefrom whose colour number is as close as possible, or even corresponds precisely, to RAL 2003, pastel orange having L*a*b* of 66.02/41.22/52.36. To this end a person skilled in the art will choose the amounts of the components to be employed in the polymer compositions according to the invention such that RAL 2003 is ideally achieved as the result.

### Through-Transmission Laser Welding

A further technical field of use for amorphous and semicrystalline polyamides is through-transmission laser welding, also known as laser transmission welding or laser welding for short. Through-transmission laser welding of plastics is based on radiation absorption in the moulding material. This is a joining process in which two joining partners generally made of thermoplastics are joined to one another on a molecular level. To this end one joining partner has a high transmission coefficient and the other a high absorption coefficient in the range of the employed laser wavelength. The joining partner having the high transmission coefficient is irradiated by the laser beam substantially without heating. Upon contact with the joining partner having the high absorption coefficient the incident laser energy is absorbed in a near-surface layer, thus converting it into heat energy and melting the plastic. Owing to heat conduction processes the laser-transparent joining partner is also plasticized in the region of the joining zone. Customary laser sources employed in laser transmission welding emit radiation in a wavelength range of approximately 600 to 1200 nm. Commonly used are in particular high output diode lasers (HDL, X=800-1100 nm) and solid-state lasers (for example Nd: YAG lasers, X=1060-1090 nm). Many non-additized polymers are largely transparent or translucent to laser radiation, i.e. they absorb only poorly. Suitable colourants, but also further additives, such as fillers and reinforcers make it possible to control the absorption and thus the conversion of laser light into heat. Often added to the absorbent joining partner are absorbent pigments, which in the case of dark joining partners are usually carbon black pigments. This approach is not possible for the laser-transparent joining partner since polymers coloured with carbon black for example show insufficient transmission for the laser light. The same applies to many organic dyes, for example nigrosin. There is therefore a need for mouldings which despite their colouring show a sufficient transmission for the laser light so that they may be used as the laser-transparent component in through-transmission laser welding.

The fundamental principles of through-transmission laser welding are known to those skilled in the art from Kunststoffe 87 (1997) 3, 348-350, Kunststoffe 87 (1997) 11, 1632-1640, Kunststoffe 88 (1998) 2, 210-121, Plastverarbeiter 46 (1995) 9, 42-46 and Plastverarbeiter 50 (1999) 4 18-19. The transmittance of a polymer moulding for laser light having a wavelength of 600 to 1200 nm may be measured for example with a spectrophotometer and an integrating photometer sphere. This set up also makes it possible to determine the diffuse fraction of the transmitted radiation. Suitable laser sources for laser transmission welding emit radiation in the abovementioned wavelength range of about 600 to 1200 nm and the abovementioned high output diode lasers or solid state lasers are employed. In terms of the polyamide-based polymer compositions to be used for through-transmission laser welding in the production of mouldings, the following embodiments will hereby be incorporated in full by reference, namely that production of a laser-transparent moulding employs substantially no components absorbent in the wavelength range of the laser used for the through-transmission laser welding. This applies especially when at least one of the components C) fillers and reinforcers, D) flame retardants or E) additives are added to the composition for the laser-transparent moulding. It is preferable when in addition to the component B) to be employed according to the invention no further additives E) that are absorbent or scattering in the wavelength range relevant to the laser process are employed for producing the laser-transparent moulding.

Production of polyamide compositions for producing mouldings for use for through-transmission laser welding is carried out by processes known per se. These typically comprise the initial mixing of the components in the relevant mass fractions. The mixing of the components is preferably carried out by conjoint blending, mixing, kneading, extruding or rolling at elevated temperatures. The temperature during mixing is preferably in a range from 220° C. to 340° C., particularly preferably from 240° C. to 300° C. and especially from 250° C. to 290° C. It may be advantageous to premix individual components. It is further also possible to directly produce the mouldings from a physical mixture produced markedly below the melting temperature of the respective polyamide (dryblend) of premixed components and/or individual components. In that case the temperature during mixing is preferably 0° C. to 100° C., particularly preferably 10° C. to 50° C., especially ambient temperature. The moulding materials may be processed into mouldings by customary processes, preferably by injection moulding or extrusion.

At the time of writing there is no standard on the basis of which a measurement of laser transparency must be carried out. A person skilled in the art accordingly proceeds with the measurement as follows: laser transparency is measured at 5 defined measuring sites on each of 5 sheets having dimensions of 60 mm. 60 mm. 2 mm and a highly polished surface. These values are used to calculate the average laser transparency. To this end the sheets are packaged in barrier PE bags before measurement and tested in the analyser in the freshly moulded state after 24 hours. See: K. D. Feddersen “Laserdurchstrahlschweißen—die Lösung für nicht lösbare Verbindungen”, Österreichische Kunststoffzeitschrift 1/2 2018, pages 50-52.

Transparency of the specimens analysed in the context of the present application was measured in the near IR range (NIR) at a laser wavelength of 980 nm in accordance with DVS guideline 2243 (01/2014) “Laserstrahlschweißen thermoplastischer Kunststoffe” using small sheets having dimensions of 60 mm·60 mm·2 mm with the LPKF TMG3 transmission analyser from LPKF Laser & Electronics AG, Garbsen, Germany previously calibrated with an analytical standard generated according to DIN EN ISO/IEC 17025; see: LPKF AG 101016-DE: “Simple transmission measurement for plastics LPKF TMG3”.

In the context of the present invention the terms laser-transparent or else laser-transmitting are used to describe polymer compositions or high-voltage components which exhibit a transmission of at least 10% at a wavelength of 980 nm. In the context of the present invention laser-absorbent is to be understood as meaning that the transmission through the above-described small sheets having a thickness of 2 mm is less than 0.1% by the abovementioned method.

### PRFERRED EMBODIMENTS

In a preferred embodiment the invention relates to compositions, high-voltage components or laser-transmitting high-voltage components, in particular high-voltage components for electromobility, containing thermoplastic polymer compositions comprising in addition to the components A) and B also C) at least one filler and/or reinforcer preferably in an amount of 1 to 150 parts by mass, particularly preferably 5 to 80 parts by mass, very particularly preferably 10 to 50 parts by mass, in each case based on 100 parts by mass of the component A).

In a further preferred embodiment the invention relates to compositions, high-voltage components or laser-transparent high-voltage components, in particular high-voltage components for electromobility, containing thermoplastic polymer compositions comprising in addition to the components A) to C) or instead of C) also D) at least one flame retardant preferably in an amount of 3 to 100 parts by mass, particularly preferably 5 to 80 parts by mass, very particularly preferably 10 to 50 parts by mass, in each case based on 100 parts by mass of the component A).

In a further preferred embodiment the invention relates to compositions, high-voltage components or laser-transparent high-voltage components, in particular high-voltage components for electromobility, containing thermoplastic polymer compositions comprising in addition to the components A) to E) or instead of C) and/or D) also E) at least one further additive different from the components B), C) and D) preferably in an amount of 0.01 to 80 parts by mass, particularly preferably 0.05 to 50 parts by mass, very particularly preferably 0.1 to 30 parts by mass, in each case based on 100 parts by mass of the component A).

### Component A)

The polyamides for use as component A) according to the invention may be produced by various processes and synthesized from different monomers. A very wide variety of procedures have become known for producing polyamides and depending on the desired end product different monomer units and different chain transfer agents may be used to establish a desired molecular weight or else monomers having reactive groups may be used for aftertreatments intended at a later stage.

The industrially relevant processes for producing polyamides usually proceed via polycondensation in the melt. In the context, the hydrolytic polymerization of lactams is also regarded as polycondensation.

Contemplated reactants include aliphatic and/or aromatic dicarboxylic acids such as adipic acid, 2,2,4- and 2,4,4-trimethyladipic acid, azelaic acid, sebacic acid, isophthalic acid, terephthalic acid, aliphatic and/or aromatic diamines such as for example tetramethylenediamine, hexamethylenediamine, 1,9-nonanediamine, 2,2,4- and 2,4,4-trimethylhexamethylenediamine, the isomeric diaminodicyclohexylmethanes, diaminodicyclohexylpropanes, bisaminomethylcyclohexane, phenylenediamines, xylylenediamines, aminocarboxylic acids such as for example aminocaproic acid and the corresponding lactams. It is particularly preferable to employ caprolactams, in particular ε-caprolactam. Copolyamides of two or more of the recited monomers are included.

Preferred polyamides are semicrystalline polyamides producible from diamines and dicarboxylic acids and/or lactams having at least 5 ring members or corresponding amino acids.

Particularly preferred polyamides include polyamide 6, polyamide 66, polyamide 46 and/or semiaromatic copolyamides. Preferred semiaromatic copolyamides are PA6T/6, PA6T/66, PA6T/6I or PA6T/6I/66.

Polyamides which are very particularly preferred according to the invention are polyamide 6 and polyamide 66, wherein polyamide 6 is especially very particularly preferred.

The designation of the polyamides employed in the context of the present application corresponds to the international standard ISO 1874-1, wherein the first digit(s) indicate(s) the carbon atom number of the starting diamine and the last digit(s) indicate(s) the carbon atom number of the dicarboxylic acid. If only one digit is indicated, such as in the case of PA6, this means that the starting material is an a,w-aminocarboxylic acid or the lactam derived therefrom, i.e. from the ε-caprolactam in the case of PA 6.

The PA6 preferred for use as component A) according to the invention [CAS no. 25038-54-4] preferably has a viscosity number to be determined in a 0.5% by weight solution in 96% by weight sulfuric acid at 25° C. according to ISO 307 in the range from 80 to 180 ml/g, particularly preferably in the range from 85 to 160 ml/g and very particularly preferably in the range from 90 to 140 ml/g. Polyamide 6 to be employed as component A) preferably according to the invention is obtainable for example from Lanxess Deutschland GmbH, Cologne under the name Durethan® B26.

It is preferable when a polyamide 66 for use as component A) [CAS no. 32131-17-2] has a viscosity number to be determined in a 0.5% by weight solution in 96% by weight sulfuric acid at 25° C. according to ISO 307 in the range from 80 to 180 ml/g, very particularly preferably a viscosity number in the range from 85 to 160 ml/g, especially preferably in the range from 90 to 140 ml/g. Polyamide 66 to be employed as component A) according to the invention is obtainable for example from BASF SE, Ludwigshafen under the name Ultramid® A24E01.

The polyamide for use as component A) according to the invention may also be employed in admixture with at least one other polyamide and/or at least one other polymer. Preferred other polymers are selected from the group of polyethylene, polypropylene and acrylonitrile-butadiene-styrene copolymer (ABS). When at least one further polyamide or at least one other polymer is used this is preferably or optionally done using at least one compatibilizer.

The polyamide for use as component A) may be admixed already in the melt with customary additives, preferably demoulding agents, stabilizers and/or flow auxiliaries known to a person skilled in the art.

Polymer compositions containing at least polyamide 6 and 10,10′-oxy-bis-12H-phthaloperin-12-one are therefore preferred according to the invention.

Polymer compositions containing polyamide 66 and 10,10′-oxy-bis-12H-phthaloperin-12-one are also preferred according to the invention.

Polymer compositions employing 0.01 to 5 parts by mass, particularly preferably 0.01 to 3 parts by mass, of 10,10′-oxy-bis-12H-phthaloperin-12-one per 100 parts by mass of polyamide 6 or polyamide 66 are also preferred.

Polymer compositions employing 0.01 to 5 parts by mass, particularly preferably 0.01 to 3 parts by mass, of 10,10′-oxy-bis-12H-phthaloperin-12-one per 100 parts by mass of polyamide 6 are also preferred.

Compositions employing 0.01 to 5 parts by mass, particularly preferably 0.01 to 3 parts by mass, of 10,10′-oxy-bis-12H-phthaloperin-12-one per 100 parts by mass of polyamide 66 are also preferred.

The invention however also provides high-voltage components, in particular high-voltage components for electromobility, based on polymer compositions containing at least one polyamide 6 or polyamide 66 and 10,10′-oxy-bis-12H-phthaloperin-12-one.

The invention however also provides high-voltage components, in particular high-voltage components for electromobility, based on polymer compositions containing polyamide 6 and 10,10′-oxy-bis-12H-phthaloperin-12-one.

The invention however also provides high-voltage components, in particular high-voltage components for electromobility, based on polymer compositions containing polyamide 66 and 10,10′-oxy-bis-12H-phthaloperin-12-one.

The invention however also provides high-voltage components, in particular high-voltage components for electromobility, based on polymer composition containing 0.01 to 5 parts by mass, particularly preferably 0.01 to 3 parts by mass, of 10,10′-oxy-bis-12H-phthaloperin-12-one per 100 parts by mass of polyamide 6 or polymide 66.

The invention however also provides high-voltage components, in particular high-voltage components for electromobility, based on polymer compositions containing 0.01 to 5 parts by mass, particularly preferably 0.01 to 3 parts by mass, of 10,10′-oxy-bis-12H-phthaloperin-12-one per 100 parts by mass of polyamide 6.

The invention however also provides high-voltage components, in particular high-voltage components for electromobility, based on polymer compositions containing 0.01 to 5 parts by mass, particularly preferably 0.01 to 3 parts by mass, of 10, 10′-oxy-bis-12H-phthaloperin-12-one per 100 parts by mass of polyamide 66.

The invention however also provides laser-transparent high-voltage components, in particular high-voltage components for electromobility, based on polymer compositions containing 0.01 to 3 parts by mass of 10,10′-oxy-bis-12H-phthaloperin-12-one per 100 parts by mass of polyamide 6 or polyamide 66 with the proviso that laser-absorbent components are eschewed.

The invention however also provides laser-transparent high-voltage components, in particular high-voltage components for electromobility, based on polymer compositions containing 0.01 to 3 parts by mass of 10,10′-oxy-bis-12H-phthaloperin-12-one per 100 parts by mass of polyamide 6 with the proviso that laser-absorbent components are eschewed.

The invention however also provides laser-transparent high-voltage components, in particular high-voltage components for electromobility, based on polymer compositions containing 0.01 to 3 parts by mass of 10,10′-oxy-bis-12H-phthaloperin-12-one per 100 parts by mass of polyamide 66 with the proviso that laser-absorbent components are eschewed.

The present invention however also relates to the use of 10, 10′-oxy-bis-12H-phthaloperin-12-one for producing polyamide 6-based polymer compositions, preferably polyamide 6-based high-voltage components, in particular polyamide 6-based high-voltage components for electromobility.

The present invention however also relates to the use of 10, 10′-oxy-bis-12H-phthaloperin-12-one for producing polyamide 66-based polymer compositions, preferably polyamide 66-based high-voltage components, in particular polyamide 66-based high-voltage components for electromobility.

The invention finally relates to the use of 10,10′-oxy-bis-12H-phthaloperin-12-one for marking polyamide 6-or polyamide 66-based articles of manufacture as high-voltage components.

The invention finally relates to the use of 10,10′-oxy-bis-12H-phthaloperin-12-one for marking polyamide 6-based articles of manufacture as high-voltage components.

The invention finally relates to the use of 10,10′-oxy-bis-12H-phthaloperin-12-one for marking polyamide 66-based articles of manufacture as high-voltage components.

### Component B)

Employed as component B) according to the invention is 10,10′-oxy-bis-12H-phthaloperin-12-one [CAS No. 203576-97-0] of formula (I)

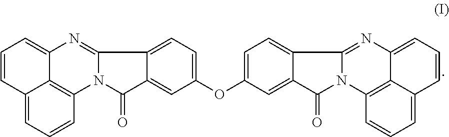 [SMILES: O=C1c2cc(Oc3ccc4c(c3)C(=O)N3C4=Nc4cccc5cccc3c45)ccc2C2=Nc3cccc4cccc(c34)N12]

10,10′-oxy-bis-12H-phthaloperin-12-one may either be produced by the synthetic route recited in EP 1 118 640 A1 under example 3) or is obtainable from Angene International Limited, UK Office, Churchill House, London.

10,10′-oxy-bis-12H-phthaloperin-12-one may be employed directly as a powder or else in the form of a masterbatch, compact or concentrate, wherein masterbatches are preferred and masterbatches in a polymer matrix corresponding to the particular component A) are particularly preferred.

### Component C)

In a preferred embodiment at least one filler or reinforcer is employed as component C). It is also possible in this case to employ mixtures of two or more different fillers and/or reinforcers.

Preference is given to using at least one filler or reinforcer from the group of carbon fibres [CAS No. 7440-44-0], glass beads or solid or hollow glass beads, or glass fibres, or milled glass, amorphous quartz glass, aluminium borosilicate glass having an alkali content of 1% (E glass) [CAS No. 65997-17-3], amorphous silica [CAS No. 7631-86-9], quartz flour [CAS No. 14808-60-7], calcium silicate [CAS No. 1344-95-2], calcium metasilicate [CAS No. 10101-39-0], magnesium carbonate [CAS No. 546-93-0], kaolin [CAS No. 1332-58-7], calcined kaolin [CAS No. 92704-41-1], chalk [CAS No.1317-65-3], kyanite [CAS No. 1302-76-7], powdered or milled quartz [CAS No. 14808-60-7], mica [CAS No. 1318-94-1], phlogopite [CAS No. 12251-00-2], barium sulfate [CAS No. 7727-43-7], feldspar [CAS No. 68476-25-5], wollastonite [CAS No. 13983-17-0], montmorillonite [CAS No. 67479-91-8], pseudoboehmite of formula AIO (OH), magnesium carbonate [CAS Nr. 12125-28-9] and talc [CAS No. 14807-96-6].

Among the fibrous fillers or reinforcers, glass fibres and wollastonite are particularly preferred, wherein glass fibres are very particularly preferred. In the case of a laser-absorbent component part/laser absorbent high-voltage component carbon fibres may also be used as a filler or reinforcer.

According to “http://de.wikipedia.org/wiki/Faser-Kunststoff-Verbund”, regarding the glass fibres a person skilled in the art distinguishes between chopped fibres, also called short fibres, having a length in the range from 0.1 to 1 mm, long fibres having a length in the range from 1 to 50 mm, and continuous fibres having a length L>50 mm. Short fibres are preferably employed in injection moulding technology and may be directly processed with an extruder. Long fibres can likewise still be processed in extruders. Said fibres are widely used in fibre spraying. Long fibres are frequently added to thermosets as a filler. Endless fibres are used in fibre-reinforced plastics in the form of rovings or fabric. Articles of manufacture comprising endless fibres achieve the highest stiffness and strength values. Also available are milled glass fibres whose length after milling is typically in the range from 70 to 200 μm.

Glass fibres preferably employable as component C) according to the invention are chopped long glass fibres having an average starting length to be determined by laser diffraction-particle size analysis (laser granulomery/laser diffractometry) according to ISO 13320 in the range from 1 to 50 mm, particularly preferably in the range from 1 to 10 mm, very particularly preferably in the range from 2 to 7 mm. For laser diffraction particle size determination/laser diffractometry according to the standard ISO 13320.

Preferred glass fibres for use as component C) have an average fibre diameter to be determined by laser diffractometry according to ISO 13320 in the range from 7 to 18 μm, particularly preferably in the range from 9 to 15 μm.

In a preferred embodiment the glass fibres preferred for use as component C) are modified with a suitable size system or an adhesion promoter/adhesion promoter system. It is preferable when a silane-based size system/adhesion promoter is employed. Particularly preferred silane-based adhesion promoters for the treatment of the glass fibres preferred for use as component C) are silane compounds of general formula (II)

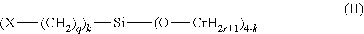

in which

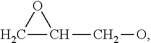

X is NH₂—, carboxyl-, HO— or
q in formula (XI) stands for an integer from 2 to 10, preferably 3 to 4,
r in formula (XI) stands for an integer from 1 to 5, preferably 1 to 2, and
k in formula (XI) stands for an integer from 1 to 3, preferably 1.

Especially preferred adhesion promoters are silane compounds from the group of aminopropyltrimethoxysilane, aminobutyltrimethoxysilane, aminopropyltriethoxysilane, aminobutyltriethoxysilane and the corresponding silanes comprising as the substituent X a glycidyl group or a carboxyl group, wherein carboxyl groups are especially very particularly preferred.

For the modification of the glass fibres preferred for use as component C), the adhesion promoter, preferably the silane compounds of formula (II), is employed preferably in amounts of 0.05% to 2% by weight, particularly preferably in amounts of 0.25% to 1.5% by weight and very particularly preferably in amounts of 0.5% to 1% by weight in each case based on 100% by weight of component C).

As a consequence of the processing to afford the composition/to afford the article of manufacture the glass fibres preferred for use as component C) may be shorter in the composition/in the article of manufacture than the originally employed glass fibres. Thus the arithmetic average of the glass fibre length after processing for determination by high-resolution x-ray computed tomography is frequently only still in the range from 150 μm to 300 μm.

According to “http://www.r-g.de/wiki/Glasfasern” glass fibres are produced in the melt spinning process (die drawing, rod drawing and die blowing processes). In the die drawing process, the hot mass of glass flows under gravity through hundreds of die bores of a platinum spinneret plate. The filaments can be drawn at a speed of 3-4 km/minute with unlimited length.

Those skilled in the art distinguish between different types of glass fibres, some of which are listed here by way of example:
E glass, the most commonly used material having an optimal cost-benefit ratio (E glass from R&G)
H glass, hollow glass fibres for reduced weight (R&G hollow glass fibre fabric 160 g/m² and 216 g/m²)
R, S glass, for elevated mechanical requirements (S2 glass from R&G)
D glass, borosilicate glass for elevated electrical requirements
C glass, having increased chemicals resistance
Quartz glass, having high thermal stability

Further examples are found at “http://de.wikipedia.org/wiki/Glasfaser”. E glass fibres have gained the greatest importance for plastics reinforcing. E stands for electrical glass, since it was originally used in the electrical industry in particular.

For the production of E glass, glass melts are produced from pure quartz with additions of limestone, kaolin and boric acid. As well as silicon dioxide, they contain different amounts of various metal oxides. The composition determines the properties of the products.

Preferably employed according to the invention is at least one type of glass fibres from the group of E glass, H glass, R, S glass, D glass, C glass and quartz glass, particular preferably glass fibres made of E glass.

Glass fibres made of E glass are the most commonly used reinforcing material. The strength characteristics correspond to those of metals (for example aluminium alloys) wherein the specific weight of laminates containing E glass fibres is lower than that of metals. E glass fibres are nonflammable, heat resistant up to about 400° C. and resistant to most chemicals and weathering effects.

Also preferably employed as component C) are also acicular mineral fillers. According to the invention the term acicular mineral fillers is to be understood as meaning a mineral filler having a highly pronounced acicular character. The acicular mineral filler preferred for use as component C) is wollastonite. The acicular mineral filler preferably has a length: diameter ratio for determination by high-resolution x-ray computed tomography in the range from 2:1 to 35:1, particularly preferably in the range from 3:1 to 19:1, especially preferably in the range from 4:1 to 12:1. The average particle size of the acicular mineral fillers for determination by high-resolution x-ray computed tomography is preferably less than 20 μm, particularly preferably less than 15 μm, especially preferably less than 10 μm.

Also preferably employed as component C) however is non-fibrous and non-foamed milled glass having a particle size distribution to be determined by laser diffractometry according to ISO 13320 having a d90 in the range from 5 to 250 μm, preferably in the range from 10 to 150 μm, particularly preferably in the range from 15 to 80 μm, very particularly preferably in the range from 16 to 25 μm. In terms of the d90 values, their determination and their significance, reference is made to Chemie Ingenieur Technik (72) pp. 273-276, 3/2000, Wiley-VCH Verlags GmbH, Weinheim, 2000, according to which the d90 value is that particle size below which 90% of the amount of particles lie.

It is preferable according to the invention when the non-fibrous and non-foamed milled glass has a particulate, non-cylindrical shape and has a length to thickness ratio to be determined by laser diffractometry according to ISO 13320 of less than 5, preferably less than 3, particularly preferably less than 2. It will be appreciated that the value of zero is impossible.

The non-foamed and non-fibrous milled glass particularly preferred for use as component C) is additionally characterized in that it does not have the glass geometry typical of fibrous glass with a cylindrical or oval cross section having a length to diameter ratio (L/D ratio) to be determined by laser diffractometry according to ISO 13320 greater than 5.

The non-foamed and non-fibrous milled glass particularly preferred for use as component C) according to the invention is preferably obtained by milling glass with a mill, preferably a ball mill and particularly preferably with subsequent sifting or sieving. Preferred starting materials for the milling of the non-fibrous and non-foamed milled glass for use as component C) in one embodiment also include glass wastes such as are generated as unwanted byproduct and/or as off-spec primary product (so-called offspec goods) in particular in the production of glass articles of manufacture. This includes in particular waste glass, recycled glass and broken glass such as may be generated in particular in the production of window or bottle glass and in the production of glass-containing fillers and reinforcers, in particular in the form of so-called melt cakes. The glass may be coloured, wherein non-coloured glass is preferred as the starting material for use as component C).

### Component D)

In a preferred embodiment at least one flame retardant is employed as component D). Preferred flame retardants are mineral flame retardants, nitrogen-containing flame retardants or phosphorus-containing flame retardants distinct from component C).

Among the mineral flame retardants magnesium hydroxide is particularly preferred. Magnesium hydroxide [CAS No. 1309-42-8] may be impurified as a result of its origin and mode of production. Typical impurities include for example silicon-, iron-, calcium- and/or aluminium-containing species which may for example be present in the form of oxides as guest species in the magnesium hydroxide crystals. The magnesium hydroxide for use as a mineral flame retardant may be unsized or else sized. The magnesium hydroxide for use as a mineral flame retardant is preferably provided with sizes based on stearates or aminosiloxanes, particularly preferably with aminosiloxanes. Magnesium hydroxide preferred for use as a mineral flame retardant has an average particle size d50 to be determined by laser diffractometry according to ISO 13320 in the range from 0.5 μm to 6 μm, wherein a d50 in the range from 0.7 μm to 3.8 μm is preferred and a d50 in the range from 1.0 μm to 2.6 μm is particularly preferred.

Magnesium hydroxide types suitable as a mineral flame retardant according to the invention include for example Magnifin@ H5IV from Martinswerk GmbH, Bergheim, Germany or Hidromag® Q2015 TC from Penoles, Mexico City, Mexico.

Preferred nitrogen-containing flame retardants are the reaction products of trichlorotriazine, piperazine and morpholine of CAS No. 1078142 Feb. 5, in particular MCA PPM Triazine HF from MCA Technologies GmbH, Biel-Benken, Switzerland, also melamine cyanurate and condensation products of melamine, in particular melem, melam, melon or more highly condensed compounds of this type. Preferred inorganic nitrogen-containing compounds are ammonium salts.

Also employable are salts of aliphatic and aromatic sulfonic acids and mineral flame retardant additives, especially aluminium hydroxide or Ca-Mg carbonate hydrates (DE-A 4 236 122).

Also suitable for use as component D) are flame retardant synergists from the group of oxygen-, nitrogen- or sulfur-containing metal compounds. Preferred among these are zinc-free compounds, especially molybdenum oxide, magnesium oxide, magnesium carbonate, calcium carbonate, calcium oxide, titanium nitride, magnesium nitride, calcium phosphate, calcium borate, magnesium borate or mixtures thereof.

However, in an alternative embodiment it is also possible to employ zinc-containing compounds as component D) if required. These preferably include zinc oxide, zinc borate, zinc stannate, zinc hydroxystannate, zinc sulfide and zinc nitride, or mixtures thereof.

Preferred phosphorus-containing flame retardants are organic metal phosphinates, aluminium salts of phosphonic acid, red phosphorus, inorganic metal hypophosphites, metal phosphonates, derivatives of 9,10-dihydro-9-oxa-10-phosphaphenanthrene 10-oxides (DOPO derivatives), resorcinol bis(diphenyl phosphate) (RDP) including oligomers, bisphenol A bis(diphenyl phosphate) (BDP) including oligomers, melamine pyrophosphate, melamine polyphosphate, melamine poly(aluminium phosphate), melamine poly(zinc phosphate) or phenoxyphosphazene oligomers and mixtures thereof.

A preferred organic metal phosphinate is aluminium tris(diethylphosphinate). A preferred inorganic metal hypophosphite is aluminium hypophosphite.

Further flame retardants for use as component D) are char formers, particularly preferably phenol-formaldehyde resins, polycarbonates, polyimides, polysulphones, polyether sulphones or polyether ketones, and also antidrip agents, in particular tetrafluoroethylene polymers.

The flame retardants to be employed as component D) may be added in pure form, or else via masterbatches or compactates.

However, in an alternative embodiment—if required and taking into account the disadvantages of loss of freedom from halogen of the flame retardants—halogen-containing flame retardants may also be employed as flame retardants. Preferred halogen-containing flame retardants are commercially available organic halogen compounds, particularly preferably ethylene-1,2-bistetrabromophthalimide, decabromodiphenylethane, tetrabromobisphenol A epoxy oligomer, tetrabromobisphenol A oligocarbonate, tetrachlorobisphenol A oligocarbonate, polypentabromobenzyl acrylate, brominated polystyrene or brominated polyphenylene ethers, which can be used alone or in combination with synergists, especially antimony trioxide or antimony pentoxide, wherein among the halogenated flame retardants brominated polystyrene is particularly preferred. Brominated polystyrene is employed in amounts of preferably 10-30% by weight, particularly preferably 15-25% by weight, in each case based on the total composition, wherein at least one of the other components is reduced to such an extent that all weight percentages always sum to 100.

Brominated polystyrene is commercially available in a very wide variety of product qualities. Examples thereof are for example Firemaster® PBS64 from Lanxess, Cologne, Germany and Saytex® HP-3010 from Albemarle, Baton Rouge, USA.

Among the flame retardants for use as component D) aluminium tris(diethylphosphinate) [CAS No. 225789-38-8] and the combination of aluminium tris(diethylphosphinate) and melamine polyphosphate or the combination of aluminium tris(diethylphosphinate) and at least one aluminium salt of phosphonic acid are very particularly preferred, where the latter combination is especially preferred.

Aluminium tris(diethylphosphinate) [CAS No. 225789-38-8] or the combinations of aluminium tris(diethylphosphinate) and melamine polyphosphate or of aluminium tris(diethylphosphinate) and at least one aluminium salt of phosphonic acid are employed in amounts of preferably 5-35% by weight, particularly preferably 10-30% by weight, very particularly preferably 15-25% by weight, in each case based on the total composition, wherein at least one of the other components is reduced to such an extent that all weight percentages always sum to 100.

In the case of combinations of aluminium tris(diethylphosphinate) and melamine polyphosphate or of aluminium tris(diethylphosphinate) and at least one aluminium salt of phosphonic acid the proportion of aluminium tris(diethylphosphinate) is preferably 40-90 parts by weight, particularly preferably 50-80 parts by weight, very particularly preferably 60-70 parts by weight, in each case based on 100 parts by weight of the combination of aluminium tris(diethylphosphinate) and melamine polyphosphate or the combination of aluminium tris(diethylphosphinate) and at least one aluminium salt of phosphonic acid.

A suitable aluminium tris(diethylphosphinate) for use as component D) is for example Exolit® OP1230 or Exolit® OP1240 from Clariant International Ltd. Muttenz, Switzerland. Melamine polyphosphate is commercially available in a very wide variety of product qualities. Examples thereof are for example Melapur® 200/70 from BASF, Ludwigshafen, Germany, and also Budit® 3141 from Budenheim, Budenheim, Germany.

Preferred aluminium salts of phosphonic acid are selected from the group
primary aluminium phosphonate [Al(H₂PO₃)₃],
basic aluminium phosphonate [Al((OH)H₂PO₃)₂·2H₂O],
Al₂(HPO₃)₃·X Al₂O₃·n H₂O₂O where x is in the range from 2.27 to 1 and n is in the range from 0 to 4,

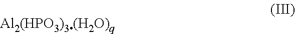

where q is in the range from 0 to 4, in particular aluminium phosphonate tetrahydrate [Al₂(HPO₃)₃·4H₂O] or secondary aluminium phosphonate [Al₂(HPO₃)₃],

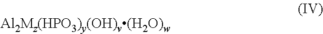

in which M represents alkali metal ion(s) and z is in the range from 0.01 to 1.5, y is in the range from 2.63-3.5, v is in the range from 0 to 2 and w is in the range from 0 to 4, and

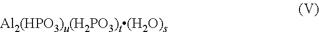

in which u is in the range of 2 to 2.99, t is in the range from 2 to 0.01 and s is in the range from 0 to 4,
wherein in formula (IV) z, y and v and in formula (V) u and t can assume only numbers such that the relevant aluminium salt of phosphonic acid as a whole is uncharged.

Preferred alkali metals M in formula (IV) are sodium and potassium.

The described aluminium salts of phosphonic acid may be used individually or in admixture.

Particularly preferred aluminium salts of phosphonic acid are selected from the group
primary aluminium phosphonate [Al(H₂PO₃)₃],
secondary aluminium phosphonate [Al₂(HPO₃)₃],
basic aluminium phosphonate [Al((OH)H₂PO₃)₂·2H₂O],
aluminium phosphonate tetrahydrate [Al₂(HPO₃)₃·4H₂O] and Al₂(HPO₃)_{3·}X Al₂O_{3·}n H₂O₂O where x is in the range from 2.27 to 1 and n is in the range from 0 to 4.

Very particular preference is given to secondary aluminium phosphonate Al2(HPO₃)₃[CAS No. 71449-76-8] and secondary aluminium phosphonate tetrahydrate Al₂(HPO₃)₃·4H₂O [CAS No. 156024-71-4], secondary aluminium phosphonate Al₂(HPO₃)₃ being especially preferred.

The production of aluminium salts of phosphonic acid for use as component D) according to the invention is described in WO 2013/083247 A1 for example. It typically comprises reacting an aluminium source, preferably aluminium isopropoxide, aluminium nitrate, aluminium chloride or aluminium hydroxide, with a phosphorus source, preferably phosphonic acid, ammonium phosphonate, alkali metal phosphonate, and optionally with a template in a solvent at 20° C. to 200° C. over a period of up to 4 days. To this end the aluminium source and the phosphorus source are mixed, heated under hydrothermal conditions or under reflux, filtered, washed and dried. Preferred templates are 1,6-hexanediamine, guanidine carbonate or ammonia. Water is preferred as the solvent.

### Component E)

Employed as component E) is at least one further additive distinct from the components B) to D). Preferred additives for use as component E) are antioxidants, heat stabilizers, UV stabilizers, gamma ray stabilizers, components for reducing water absorption/hydrolysis stabilizers, antistats, emulsifiers, nucleating agents, plasticizers, processing aids, impact modifiers, lubricants and/or demoulding agents, components for reducing water absorption, flow auxiliaries or elastomer modifiers, chain-extending additives, colourants that are distinct from component B), in the case of laser-absorbing components or high-voltage components, laser absorbers. The additives can be used either alone or in admixture or in the form of masterbatches.

Preferred heat stabilizers of component E) are sterically hindered phenols, in particular those containing at least one 2,6-di-tert-butylphenyl group and/or 2-tert-butyl-6-methylphenyl group, phosphites, hypophosphites, in particular sodium hypophosphite NaH₂PO₂, hydroquinones, aromatic secondary amines, substituted resorcinols, salicylates, benzotriazoles and benzophenones, 3,3′-thiodipropionate esters and variously substituted representatives of these groups or mixtures thereof.

In one embodiment copper salts, preferably in combination with sodium hypophosphite NaH₂PO₂, may also be employed as heat stabilizers of the component E). It is preferable to employ as the copper salt copper (I) iodide [CAS No. 7681-65-4] and/or copper(triphenylphosphino) iodide [CAS No. 47107-74-4]. The copper salts are preferably employed in combination with sodium hypophosphite NaH₂PO₂ or with at least one alkali metal iodide. The preferred alkali metal iodide is potassium iodide [CAS No. 7681-11-0].

Heat stabilizers for use as component E) are preferably used in amounts of 0.01 to 2 parts by mass, particularly preferably 0.05 to 1 parts by mass, in each case based on 100 parts by mass of the component A).

Preferably employed as UV stabilizers for use as component E) are substituted resorcinols, salicylates, benzotriazoles and benzophenones, HALS derivatives (“Hindered Amine Light Stabilizers”) containing at least one 2,2,6,6-tetramethyl-4-piperidyl unit or benzophenones.

UV stabilizers for use as component E) are employed in amounts of preferably 0.01 to 2 parts by mass, particularly preferably 0.1 to 1 parts by mass, in each case based on 100 parts by mass of the component A).

Preferably employed as colourants for use as component E) and distinct from component B) are inorganic pigments, in particular ultramarine blue, bismuth vanadate, iron oxide, titanium dioxide, zinc sulfide, zinc-titanium-zinc oxides [CAS No. 923954-49-8] and also organic dyes, preferably phthalocyanines, quinacridones, benzimidazoles, in particular Ni-2-hydroxy-napthyl-benzimidazole [CAS No. 42844-93-9] and/or pyrimidine-azo-benzimidazole [CAS No. 72102-84-2] and/or Pigment Yellow 192 [CAS No. 56279-27-7] as well as perylenes, anthraquinones, in particular C. I. Solvent Yellow 163 [CAS No. 13676-91-0], this list being nonexhaustive.

In one embodiment, preferably in the case of a laser-absorbent component part/high-voltage component, carbon black or nigrosin are also used as a colourant.

Preferably employed as nucleating agents for use as component E) are sodium or calcium phenylphosphinate, aluminium oxide or silicon dioxide and very particularly preferably talc, this list being nonexclusive. Preferably employed as flow auxiliaries for use as component E) are copolymers of at least one a-olefin with at least one methacrylic ester or acrylic ester of an aliphatic alcohol. Particularly preferred here are copolymers where the α-olefin is constructed from ethene and/or propene and the methacrylic ester or acrylic ester comprises as its alcohol component linear or branched alkyl groups having 6 to 20 carbon atoms. Very particular preference is given to 2-ethylhexyl acrylate. Features of the copolymers suitable as flow auxiliaries are not just their composition but also their low molecular weight. Accordingly, suitable copolymers for the compositions that are to be protected from thermal degradation in accordance with the invention are particularly those which have an MFI value measured at 190° C. and a load of 2.16 kg of at least 100 g/10 min, preferably of at least 150 g/10 min, more preferably of at least 300 g/10 min. The MFI, melt flow index, characterizes the flow of a melt of a thermoplastic and is subject to the standards ISO 1133 or ASTM D 1238. Especially preferably employed as a flow auxiliary is a copolymer of ethene and 2-ethylhexyl acrylate having an MFI of 550 and known as Lotryl® 37EH550.

Preferably employed as chain-extending additives for use as component E) are di- or polyfunctional branching or chain-extending additives containing at least two branching or chain-extending functional groups per molecule. Preferred branching or chain-extending additives include low molecular weight or oligomeric compounds which have at least two chain-extending functional groups per molecule which are capable of reacting with primary and/or secondary amino groups and/or amide groups and/or carboxylic acid groups. Chain-extending functional groups are preferably isocyanates, alcohols, blocked isocyanates, epoxides, maleic anhydride, oxazoline, oxazine, oxazolone, preference being given to epoxides.

Especially preferred di- or polyfunctional branching or chain-extending additives are diepoxides based on diglycidyl ethers (bisphenol and epichlorohydrin), based on amine epoxy resin (aniline and epichlorohydrin), based on diglycidyl esters (cycloaliphatic dicarboxylic acids and epichlorohydrin), separately or in mixtures, and also 2,2-bis[p-hydroxyphenyl] propane diglycidyl ether, bis[p-(N-methyl-N-2,3-epoxypropylamino)phenyl]methane and epoxidized fatty acid esters of glycerol comprising at least two epoxy groups per molecule.

Particularly preferred di- or polyfunctional branching or chain-extending additives are glycidyl ethers, very particularly preferably bisphenol A diglycidyl ether [CAS No. 98460-24-3] or epoxidized fatty acid esters of glycerol and also very particularly preferably epoxidized soya oil [CAS No. 8013 Jul. 8] and/or epoxidized linseed oil.

Plasticizers preferred for use as component E) are dioctyl phthalate, dibenzyl phthalate, butyl benzyl phthalate, hydrocarbon oils or N-(n-butyl)benzenesulfonamide.

Elastomer modifiers preferably employable as component E) comprise inter alia one or more graft polymers of
E.1 5% to 95% by weight, preferably 30% to 90% by weight, of at least one vinyl monomer and
E.2 95% to 5% by weight, preferably 70% to 10% by weight, of one or more graft substrates having glass transition temperatures <10° C., preferably <0° C., particularly preferably <−20° C., wherein the percentages by weight are based on 100% by weight of elastomer modifier.

The graft substrate E.2 generally has an average particle size d50 value to be determined by laser diffractometry according to ISO 13320 of 0.05 to 10 μm, preferably 0.1 to 5 μm, particularly preferably 0.2 to 1 μm.

Monomers of E.1 are preferably mixtures of
E.1.1 50% to 99% by weight of vinylaromatics and/or ring-substituted vinylaromatics, in particular styrene, a-methylstyrene, p-methylstyrene, p-chlorostyrene, and/or (C₁-C₈)-alkyl methacrylates, in particular methyl methacrylate, ethyl methacrylate and
E.1.2 1% to 50% by weight of vinyl cyanides, in particular unsaturated nitriles such as acrylonitrile and methacrylonitrile and/or (C₁-C₈)-alkyl (meth)acrylates, in particular methyl methacrylate, glycidyl methacrylate, n-butyl acrylate, t-butyl acrylate, and/or derivatives, in particular anhydrides and imides of unsaturated carboxylic acids, in particular maleic anhydride or N-phenylmaleimide, wherein the percentages by weight are based on 100% by weight of elastomer modifier.

Preferred monomers E.1.1 are to be selected from at least one of the monomers styrene, α-methylstyrene and methyl methacrylate; preferred monomers E.1.2 are selected from at least one of the monomers acrylonitrile, maleic anhydride, glycidyl methacrylate and methyl methacrylate. Particularly preferred monomers are E.1.1 styrene and E.1.2 acrylonitrile.

Graft substrates E.2 suitable for the graft polymers for use in the elastomer modifiers are, for example, diene rubbers, EPDM rubbers, i.e. those based on ethylene/propylene and optionally diene, also acrylate, polyurethane, silicone, chloroprene and ethylene/vinyl acetate rubbers. EPDM stands for ethylene-propylene-diene rubber.

Preferred graft substrates E.2 are diene rubbers, especially based on butadiene, isoprene, etc., or mixtures of diene rubbers or copolymers of diene rubbers or mixtures thereof with further copolymerizable monomers, especially of E.1.1 and E.1.2, with the proviso that the glass transition temperature of the component E.2 is <10° C., preferably <0° C., particularly preferably <−10° C.

Particularly preferred graft substrates E.2 are ABS polymers (emulsion, bulk and suspension ABS), wherein ABS stands for acrylonitrile-butadiene-styrene, as described, for example, in DE-A 2 035 390 or in DE-A 2 248 242 or in Ullmann, Enzyklopädie der Technischen Chemie, vol. 19 (1980), p. 277-295. The gel content of the graft substrate E.2 is preferably at least 30% by weight, particularly preferably at least 40% by weight (measured in toluene).

The elastomer modifiers/graft polymers for use as component E) are produced by free-radical polymerization, preferably by emulsion, suspension, solution or bulk polymerization, in particular by emulsion or bulk polymerization.

Particularly suitable graft rubbers also include ABS polymers, which are produced by redox initiation with an initiator system composed of organic hydroperoxide and ascorbic acid according to US-A 4 937 285.

Since, as is well known, the graft monomers are not necessarily completely grafted onto the graft substrate in the grafting reaction, graft polymers are also to be understood as meaning according to the invention products produced by (co)polymerization of the graft monomers in the presence of the graft substrate and co-obtained in the workup.

Likewise suitable acrylate rubbers are based on graft substrates E.2 which are preferably polymers of alkyl acrylates, optionally comprising up to 40% by weight based on E.2 of other polymerizable, ethylenically unsaturated monomers. Preferred polymerizable acrylic esters include C₁-C₈-alkyl esters, preferably methyl, ethyl, butyl, n-octyl and 2-ethylhexyl esters; haloalkyl esters, preferably halo-C₁-C₈-alkyl esters, such as chloroethyl acrylate, glycidyl esters, and mixtures of these monomers. Particularly preferred in this context are graft polymers having butyl acrylate as the core and methyl methacrylates as the shell, in particular Paraloid® EXL2300, Dow Corning Corporation, Midland Michigan, USA.

Alternatively to the ethylenically unsaturated monomers crosslinking may be achieved by copolymerizing monomers having more than one polymerizable double bond. Preferred crosslinking monomers are esters of unsaturated monocarboxylic acids having 3 to 8 carbon atoms and unsaturated monohydric alcohols having 3 to 12 carbon atoms or of saturated polyols having 2 to 4 OH groups and 2 to 20 carbon atoms, preferably ethylene glycol dimethacrylate, allyl methacrylate; polyunsaturated heterocyclic compounds, preferably trivinyl cyanurate and triallyl cyanurate; polyfunctional vinyl compounds, preferably di- and trivinylbenzenes; but also triallyl phosphate and diallyl phthalate.

Particularly preferred crosslinking monomers are allyl methacrylate, ethylene glycol dimethacrylate, diallyl phthalate and heterocyclic compounds having at least 3 ethylenically unsaturated groups.

Very particularly preferred crosslinking monomers are the cyclic monomers triallyl cyanurate, triallyl isocyanurate, triacryloylhexahydro-s-triazine, triallylbenzenes. The amount of the crosslinked monomers is preferably 0.02% to 5% by weight, in particular 0.05% to 2% by weight, based on the graft substrate E.2.

For cyclic crosslinking monomers having at least 3 ethylenically unsaturated groups it is advantageous to restrict the amount to below 1% by weight of the graft substrate E.2.

Preferred “other” polymerizable, ethylenically unsaturated monomers which, in addition to the acrylic esters, may optionally be used to produce the graft substrate E.2 are acrylonitrile, styrene, a-methylstyrene, acrylamides, vinyl C₁-C₆-alkyl ethers, methyl methacrylate, glycidyl methacrylate, butadiene. Preferred acrylate rubbers as graft substrate E.2 are emulsion polymers having a gel content of at least 60% by weight.

Further preferably suitable graft substrates of E.2 are silicone rubbers having graft-active sites, such as are described in DE-A 3 704 657, DE-A 3 704 655, DE-A 3 631 540 and DE-A 3 631 539.

Preferred graft polymers having a silicone proportion are those comprising methyl methacrylate or styrene-acrylonitrile as the shell and a silicone/acrylate graft as the core. Styrene-acrylonitrile preferred for use as the shell is Metablen® SRK200. Methyl methacrylate preferred for use as the shell is Metablen® S2001 or Metablen® S2030 or Metablen® SX-005. It is particularly preferable to employ Metablen® S2001. The products having the trade name Metablen® are available from Mitsubishi Rayon Co., Ltd., Tokyo, Japan.

Crosslinking may be achieved by copolymerizing monomers having more than one polymerizable double bond. Preferred examples of crosslinking monomers are esters of unsaturated monocarboxylic acids having 3 to 8 carbon atoms and unsaturated monohydric alcohols having 3 to 12 carbon atoms or of saturated polyols having 2 to 4 OH groups and 2 to 20 carbon atoms, preferably ethylene glycol dimethacrylate, allyl methacrylate; polyunsaturated heterocyclic compounds, preferably trivinyl cyanurate and triallyl cyanurate; polyfunctional vinyl compounds, preferably di-and trivinylbenzenes; but also triallyl phosphate and diallyl phthalate.

Preferred crosslinking monomers are allyl methacrylate, ethylene glycol dimethacrylate, diallyl phthalate and heterocyclic compounds having at least 3 ethylenically unsaturated groups.

Particularly preferred crosslinking monomers are the cyclic monomers triallyl cyanurate, triallyl isocyanurate, triacryloylhexahydro-s-triazine, triallylbenzenes. The amount of the crosslinked monomers is preferably 0.02% to 5% by weight, in particular 0.05% to 2% by weight, based on the graft substrate E.2.

For cyclic crosslinking monomers having at least 3 ethylenically unsaturated groups it is advantageous to restrict the amount to below 1% by weight of the graft substrate E.2.

Preferred “other” polymerizable, ethylenically unsaturated monomers which, in addition to the acrylic esters, may optionally be used to produce the graft substrate E.2 are acrylonitrile, styrene, a-methylstyrene, acrylamides, vinyl C₁-C₆-alkyl ethers, methyl methacrylate, glycidyl methacrylate, butadiene. Preferred acrylate rubbers as graft substrate E.2 are emulsion polymers having a gel content of at least 60% by weight.

Also employable in addition to elastomer modifiers based on graft polymers are elastomer modifiers which are not based on graft polymers and have glass transition temperatures <10° C., preferably <0° C., particularly preferably <−20° C. These preferably include elastomers having a block copolymer structure and additionally thermoplastically meltable elastomers, in particular EPM, EPDM and/or SEBS rubbers (EPM=ethylene-propylene copolymer, EPDM=ethylene-propylene-diene rubber and SEBS=styrene-ethene-butene-styrene copolymer).

Lubricants and/or demoulding agents for use as component E) are preferably long-chain fatty acids, especially stearic acid or behenic acid, salts thereof, especially calcium stearate or zinc stearate, and the ester derivatives thereof, especially those based on pentaerythritol, especially fatty acid esters of pentaerythritol or amide derivatives, especially ethylenebisstearylamide, montan waxes and low molecular weight polyethylene or polypropylene waxes.

Montan waxes in the context of the present invention are mixtures of straight-chain saturated carboxylic acids having chain lengths of 28 to 32 carbon atoms.

According to the invention particular preference is given to using lubricants and/or demoulding agents from the group of esters of saturated or unsaturated aliphatic carboxylic acids having 8 to 40 carbon atoms with aliphatic saturated alcohols or amides of amines having 2 to 40 carbon atoms with unsaturated aliphatic carboxylic acids having 8 to 40 carbon atoms or instead of the respective carboxylic acids metal salts of saturated or unsaturated aliphatic carboxylic acids having 8 to 40 carbon atoms.

Lubricants and/or demoulding agents very particularly preferred for use as component E) may be selected from the group of pentaerythritol tetrastearate [CAS No. 115-83-3], ethylenebisstearylamide, calcium stearate and ethylene glycol dimontanate. The use of calcium stearate [CAS No. 1592-23-0] or ethylenebisstearylamide [CAS No. 110-30-5] is especially preferred. The use of ethylenebisstearylamide (Loxiol® EBS from Emery Oleochemicals) is especially particularly preferred.

Hydrolysis stabilizers/components for reducing water absorption preferred for use as component E) are preferably polyesters, wherein polybutylene terephthalate and/or polyethylene terephthalate are preferred and polyethylene terephthalate is very particularly preferred. The polyesters are preferably employed in concentrations of 5% to 20% by weight and particularly preferably employed in concentrations of 7% to 15% by weight in each case based on the total polymer composition and with the proviso that all percentages by weight of the polymer composition always sum to 100% by weight.

Employable as component E) in the case of a laser-absorbent component part/laser-absorbent high-voltage component is at least one laser absorber selected from the group of antimony trioxide, tin oxide, tin orthophosphate, barium titanate, aluminium oxide, copper hydroxyphosphate, copper orthophosphate, potassium copper diphosphate, copper hydroxide, antimony tin oxide, bismuth trioxide and anthraquinone. Tin oxide, antimony trioxide or antimony tin oxide are particularly preferred. Antimony trioxide is very particularly preferred.

The laser absorber, in particular the antimony trioxide, may be used directly as a powder or in the form of masterbatches. Preferred masterbatches are those based on polyamide and/or polyolefins, preferably polyethylene. It is very particularly preferable to use antimony trioxide in the form of a nylon-6-based masterbatch.

The laser absorber may be used individually or as a mixture of two or more laser absorbers.

Laser absorbers are capable of absorbing laser light of a particular wavelength. In practice this wavelength is in the range from 157 nm to 10.6 μm. Examples of lasers of these wavelengths are described in WO2009/003976 A1. Preference is given to using Nd:YAG lasers, which can achieve wavelengths of 1064, 532, 355 and 266 nm, and CO₂ lasers.

Preferred according to the invention are high-voltage components, in particular high-voltage components for electromobility, based on polymer compositions containing
A) per 100 parts by mass of at least one polyamide, preferably nylon 6 or nylon 6,6, in particular nylon 6,
B) 0.01 to 5 parts by mass of 10,10′-oxy-bis-12H-phthaloperin-12-one and
C) 1 to 150 parts by mass of at least one filler and reinforcer to be selected from the group of glass beads or solid or hollow glass beads, or glass fibres, or milled glass, amorphous quartz glass, aluminium borosilicate glass having an alkali content of 1% (E glass), amorphous silica, quartz flour, calcium silicate, calcium metasilicate, magnesium carbonate, kaolin, calcined kaolin, chalk, kyanite, powdered or milled quartz, mica, phlogopite, barium sulfate, feldspar, wollastonite, montmorillonite, pseudoboehmite of formula AlO(OH), magnesium carbonate and talc, in particular glass fibres.

Preferred according to the invention are high-voltage components, in particular high-voltage components for electromobility, based on polymer compositions containing
A) per 100 parts by mass of at least one polyamide, preferably nylon 6 or nylon 6,6, in particular nylon 6,
B) 0.01 to 5 parts by mass of 10,10′-oxy-bis-12H-phthaloperin-12-one,
C) 1 to 150 parts by mass of at least one filler and reinforcer preferably to be selected from the group of glass beads or solid or hollow glass beads, or glass fibres, or milled glass, amorphous quartz glass, aluminium borosilicate glass having an alkali content of 1% (E glass), amorphous silica, quartz flour, calcium silicate, calcium metasilicate, magnesium carbonate, kaolin, calcined kaolin, chalk, kyanite, powdered or milled quartz, mica, phlogopite, barium sulfate, feldspar, wollastonite, montmorillonite, pseudoboehmite of formula AIO (OH), magnesium carbonate and talc, in particular glass fibres, and
D) 3 to 100 parts by mass of at least one flame retardant additive, preferably to be selected from mineral flame retardants, nitrogen-containing flame retardants or phosphorus-containing flame retardants.

Preferred according to the invention are high-voltage components, in particular high-voltage components for electromobility, based on polymer compositions containing
A) per 100 parts by mass of at least one polyamide, preferably nylon 6 or nylon 6,6, in particular nylon 6,
B) 0.01 to 5 parts by mass of 10,10′-oxy-bis-12H-phthaloperin-12-one,
C) 1 to 150 parts by mass of at least one filler and reinforcer preferably to be selected from the group of glass beads or solid or hollow glass beads, or glass fibres, or milled glass, amorphous quartz glass, aluminium borosilicate glass having an alkali content of 1% (E glass), amorphous silica, quartz flour, calcium silicate, calcium metasilicate, magnesium carbonate, kaolin, calcined kaolin, chalk, kyanite, powdered or milled quartz, mica, phlogopite, barium sulfate, feldspar, wollastonite, montmorillonite, pseudoboehmite of formula AlO(OH), magnesium carbonate and talc, in particular glass fibres, and
E) 0.01 to 2 parts by mass of at least one heat stabilizer, preferably to be selected from the group of sterically hindered phenols, in particular those containing at least one 2,6-di-tert-butylphenyl group and/or 2-tert-butyl-6-methylphenyl group, furthermore phosphites, hypophosphites, in particular sodium hypophosphite NaH₂PO₂, hydroquinones, aromatic secondary amines and 3,3′-thiodipropionates.

Preferred according to the invention are high-voltage components, in particular high-voltage components for electromobility, based on polymer compositions containing
A) per 100 parts by mass of at least one polyamide, preferably nylon 6 or nylon 6,6, in particular nylon 6,
B) 0.01 to 5 parts by mass of 10,10′-oxy-bis-12H-phthaloperin-12-one,
C) 1 to 150 parts by mass of at least one filler and reinforcer preferably to be selected from the group of glass beads or solid or hollow glass beads, or glass fibres, or milled glass, amorphous quartz glass, aluminium borosilicate glass having an alkali content of 1% (E glass), amorphous silica, quartz flour, calcium silicate, calcium metasilicate, magnesium carbonate, kaolin, calcined kaolin, chalk, kyanite, powdered or milled quartz, mica, phlogopite, barium sulfate, feldspar, wollastonite, montmorillonite, pseudoboehmite of formula AlO(OH), magnesium carbonate and talc, in particular glass fibres,
D) 3 to 100 parts by mass of at least one flame retardant additive, preferably to be selected from mineral flame retardants, nitrogen-containing flame retardants or phosphorus-containing flame retardants, and
E) 0.01 to 2 parts by mass of at least one heat stabilizer, preferably to be selected from the group of sterically hindered phenols, in particular those containing at least one 2,6-di-tert-butylphenyl group and/or 2-tert-butyl-6-methylphenyl group, furthermore phosphites, hypophosphites, in particular sodium hypophosphite NaH₂PO₂hydroquinones, aromatic secondary amines and 3,3′-thiodipropionates.

Preferred according to the invention are laser-transparent high-voltage components, in particular laser-transparent high-voltage components for electromobility, based on polymer compositions containing
A) per 100 parts by mass of at least one polyamide, preferably nylon 6 or nylon 6,6, in particular nylon 6,
B) 0.01 to 3 parts by mass of 10,10′-oxy-bis-12H-phthaloperin-12-one and
C) 1 to 150 parts by mass of at least one filler and reinforcer to be selected from the group of glass beads or solid or hollow glass beads, or glass fibres, or milled glass, amorphous quartz glass, aluminium borosilicate glass having an alkali content of 1% (E glass), amorphous silica, quartz flour, calcium silicate, calcium metasilicate, magnesium carbonate, kaolin, calcined kaolin, chalk, kyanite, powdered or milled quartz, mica, phlogopite, barium sulfate, feldspar, wollastonite, montmorillonite, pseudoboehmite of formula AlO(OH), magnesium carbonate and talc, in particular glass fibres, with the proviso that laser-absorbent additives are eschewed.

Preferred according to the invention are laser-transparent high-voltage components, in particular laser-transparent high-voltage components for electromobility, based on polymer compositions containing
A) per 100 parts by mass of at least one polyamide, preferably nylon 6 or nylon 6,6, in particular nylon 6,
B) 0.01 to 3 parts by mass of 10,10′-oxy-bis-12H-phthaloperin-12-one,
C) 1 to 150 parts by mass of at least one filler and reinforcer preferably to be selected from the group of glass beads or solid or hollow glass beads, or glass fibres, or milled glass, amorphous quartz glass, aluminium borosilicate glass having an alkali content of 1% (E glass), amorphous silica, quartz flour, calcium silicate, calcium metasilicate, magnesium carbonate, kaolin, calcined kaolin, chalk, kyanite, powdered or milled quartz, mica, phlogopite, barium sulfate, feldspar, wollastonite, montmorillonite, pseudoboehmite of formula AlO(OH), magnesium carbonate and talc, in particular glass fibres, and
D) 3 to 100 parts by mass of at least one flame retardant additive, preferably to be selected from mineral flame retardants, nitrogen-containing flame retardants or phosphorus-containing flame retardants, with the proviso that laser-absorbent additives are eschewed.

Preferred according to the invention are laser-transparent high-voltage components, in particular laser-transparent high-voltage components for electromobility, based on polymer compositions containing
A) per 100 parts by mass of at least one polyamide, preferably nylon 6 or nylon 6,6, in particular nylon 6,
B) 0.01 to 3 parts by mass of 10,10′-oxy-bis-12H-phthaloperin-12-one,
C) 1 to 150 parts by mass of at least one filler and reinforcer preferably to be selected from the group of glass beads or solid or hollow glass beads, or glass fibres, or milled glass, amorphous quartz glass, aluminium borosilicate glass having an alkali content of 1% (E glass), amorphous silica, quartz flour, calcium silicate, calcium metasilicate, magnesium carbonate, kaolin, calcined kaolin, chalk, kyanite, powdered or milled quartz, mica, phlogopite, barium sulfate, feldspar, wollastonite, montmorillonite, pseudoboehmite of formula AlO(OH), magnesium carbonate and talc, in particular glass fibres, and
E) 0.01 to 2 parts by mass of at least one heat stabilizer, preferably to be selected from the group of sterically hindered phenols, in particular those containing at least one 2,6-di-tert-butylphenyl group and/or 2-tert-butyl-6-methylphenyl group, furthermore phosphites, hypophosphites, in particular sodium hypophosphite NaH₂PO₂, hydroquinones, aromatic secondary amines and 3,3′-thiodipropionates.

Preferred according to the invention are laser-transparent high-voltage components, in particular laser-transparent high-voltage components for electromobility, based on polymer compositions containing
A) per 100 parts by mass of at least one polyamide, preferably nylon 6 or nylon 6,6, in particular nylon 6,
B) 0.01 to 3 parts by mass of 10,10′-oxy-bis-12H-phthaloperin-12-one,
C) 1 to 150 parts by mass of at least one filler and reinforcer preferably to be selected from the group of glass beads or solid or hollow glass beads, or glass fibres, or milled glass, amorphous quartz glass, aluminium borosilicate glass having an alkali content of 1% (E glass), amorphous silica, quartz flour, calcium silicate, calcium metasilicate, magnesium carbonate, kaolin, calcined kaolin, chalk, kyanite, powdered or milled quartz, mica, phlogopite, barium sulfate, feldspar, wollastonite, montmorillonite, pseudoboehmite of formula AlO(OH), magnesium carbonate and talc, in particular glass fibres,
D) 3 to 100 parts by mass of at least one flame retardant additive, preferably to be selected from mineral flame retardants, nitrogen-containing flame retardants or phosphorus-containing flame retardants, and
E) 0.01 to 2 parts by mass of at least one heat stabilizer, preferably to be selected from the group of sterically hindered phenols, in particular those containing at least one 2,6-di-tert-butylphenyl group and/or 2-tert-butyl-6-methylphenyl group, furthermore phosphites, hypophosphites, in particular sodium hypophosphite NaH₂PO₂, hydroquinones, aromatic secondary amines and 3,3′-thiodipropionates.

### Process

The present invention further relates to a process for producing the polymer compositions for use in the high-voltage components, in particular in high-voltage components for electromobility, wherein A) at least one polyamide and B) 10,10′-oxy-bis-12H-phthaloperin-12-one and optionally at least one of the further components C), D) or E) are mixed with one another in at least one mixing apparatus. It is preferable here to employ 0.01 to 5 parts by mass of 10,10′-oxy-bis-12H-phthaloperin-12-one per 100 parts by mass of at least one polyamide.

The present invention further relates to a process for producing high-voltage components, in particular high-voltage components for electromobility, by subjecting the polymer compositions to further processing by injection moulding, including the specialized processes GIT (gas injection technology), WIT (water injection technology) and PIT (projectile injection technology), by extrusion processes, including by profile extrusion, or by blow moulding. Before further processing the polymer compositions are optionally discharged to afford strands, cooled until pelletizable, optionally dried and pelletized. In one embodiment the polymer composition is intermediately stored as a granulate.

Corresponding processes also apply to the production of laser-transparent/laser-transmitting high-voltage components, wherein 0.01 to 3 parts by mass of 10,10′-oxy-bis-12H-phthaloperin-12-one are employed per 100 parts by mass of at least one polyamide.

The invention preferably relates to a process for producing high-voltage components, in particular high-voltage components for electromobility, wherein A) at least one polyamide and B) 10,10′-oxy-bis-12H-phthaloperin-12-one, preferably 0.01 to 5 parts by mass of 10,10′-oxy-bis-12H-phthaloperin-12-one per 100 parts by mass of at least one polyamide, are mixed with one another to afford polymer compositions, discharged to afford strands, cooled until pelletizable, dried and pelletized and the polymer compositions are subsequently subjected to further processing by injection moulding, including the specialized processes GIT (gas injection technology), WIT (water injection technology) and PIT (projectile injection technology), by extrusion processes, including profile extrusion, or by blow moulding.

### High-voltage Components

Preferred high-voltage components, in particular high-voltage components for electromobility, but also laser-transparent and laser-transmitting high-voltage components find use in electrical drivetrains and/or in battery systems. Particularly preferred high-voltage components are covers for electrics or electronics, control devices, covers/housings for fuses, relays, battery cell modules, fuse holders, fuse plugs, terminals, cable holders or sheathings, in particular sheathings of high-voltage bus bars.

It will be understood that the specification and examples are illustrative but not limitative of the present invention and that other embodiments within the spirit and scope of the invention will suggest themselves to those skilled in the art.

### EXAMPLES

To demonstrate the improvements in properties described in accordance with the invention, corresponding polyamide-based polymer compositions were first made up by compounding. The individual components were for this purpose mixed in a twin-screw extruder (ZSK 25 Compounder from Coperion Werner & Pfleiderer (Stuttgart, Germany)) at temperatures between 270 and 300° C., discharged as a strand, cooled until pelletizable and pelletized. After drying (generally for two days at 80° C. in a vacuum drying cabinet) the pellets were processed at temperatures in the range from 270° C. to 290° C. to afford standard test specimens for the respective tests.

In the context of the present experiments bleeding was measured via the discolouration of a 30.20.2 mm³ plasticized PVC film (P-PVC, FB110 white, standard low temperature resistance from Jedi Kunststofftechnik GmbH, Eitorf, Germany) which was stored in a hot air drying cabinet at 80° C. for 12 hours clamped between 2 60·40·2 mm³ plastic sheets based on the compositions shown in table 2. This was followed by visual evaluation according to the grey scale of ISO 105-A02, wherein ‘5’ indicates that the PVC film showed no colour change and ‘1’ indicates that the PVC film showed a strong colour change.

In the context of the present invention, the measure of lightfastness used was the discolouration of the moulding materials described in table 2 in the form of 60·40·2 mm³ sheets after UV storage with a UV light (Suntest CPS+, 300-800 nm, 45-130 klx, having Window Glass Filter 250-765 W/m² from Atlas Material Testing Technology GmbH, Linsengericht, Germany) for 96 h. Discolouration was evaluated visually based on the blue wool scale according to DIN EN ISO 105-B02, wherein ‘8’ represents exceptional lightfastness (little colour change) and ‘1’ represents very low lightfastness (strong colour change).

### Reactants

Component A) Nylon 6 (Durethan® B26, from Lanxess Deutschland GmbH, Cologne, Germany)
Component B): 10,10′-oxy-bis-12H-phthaloperin-12-one [CAS No. 203576-97-0] from Angene International Limited, London
Component X/1): 12H-Phthaloperin-12-one [CAS No. 6925-69-5] in the form of Macrolex® Orange 3G from Lanxess Deutschland GmbH, Cologne.

TABLE II

| | | Ex. 1 | Comp. 1 |
|---|---|---|---|
| Component A) | parts by weight | 100 | 100 |
| Component B) | parts by weight | 0.3 | |
| Component X/1 | parts by weight | | 0.3 |
| Bleeding | grey scale | 5 | 4 |
| Lightfastness | blue woolscale | 7 | 6 |

The results in Table Il show that inventive example 1 shows less bleeding than the material coloured with component X/1 as per the prior art in Comp. 1 and furthermore also has a higher light fastness.

What is claimed is:

1. An orange dyed polymer composition comprised of the following components:
(A) at least one polyamide, and
(B) a 10,10′-oxybis-12H-phthaloperin-12-one dye, wherein
the 10,10′-oxybis-12H-phthaloperin-12-one dye component (B) is present in an amount of 0.01 to 5 parts by mass per 100 parts by mass of the at least one polyamide component (A) which is sufficient to achieve (i) an orange color corresponding to a color distance ΔE <20 from the L*a*b* coordinates of a color number beginning with “2” in the RAL color chart, and (ii) reduced contact bleeding of the 10,10′-oxybis-12H-phthaloperin-12-one component (B) as compared to a polymer composition having 12H-phthaloperin-12-one as component (B).

2. The polymer composition according to claim 1, wherein the polymer composition comprises 0.01 to 3 parts by mass of the 10,10′-oxybis-12H-phthaloperin-12 component (B) per 100 parts by mass of the at least one polyamide component (A).

3. The polymer composition according to claim 2, wherein the polymer composition further comprises the following component:
(C) at least one filler and/or reinforcer.

4. The polymer composition according to claim 3, wherein the polymer composition further comprises the component:
(D) at least one flame retardant.

5. The polymer composition according to claim 4, wherein the polymer composition further comprises the component:
(E) at least one further additive other than the components (B), (C) and (D).

6. The polymer composition according to claim 3, wherein the filler and/or reinforcer component (C) is selected from the group consisting of solid glass beads, hollow glass beads, glass fibers, ground glass, amorphous quartz glass, aluminum borosilicate glass having an alkali content of 1% (E glass), amorphous silica, quartz flour, calcium silicate, calcium metasilicate, magnesium carbonate, kaolin, calcined kaolin, chalk, kyanite, powdered or ground quartz, mica, phlogopite, barium sulfate, feldspar, wollastonite, montmorillonite, pseudoboehmite of the formula AlO(OH), magnesium carbonate and talc.

7. The polymer composition according to claim 4, wherein the at least one flame retardant component (D) is selected from mineral flame retardants, nitrogen-containing flame retardants and phosphorus-containing flame retardants.

8. The polymer composition according to claim 5, wherein the at least one additive component (E) is at least on heat stabilizer.

9. The polymer composition according to claim 5, wherein the polymer composition comprises, based on 100 parts by mass of the at least one polyamide (A):
(B) 0.01 to 5 parts by mass of the 10, 10′-oxybix-12H-phthaloperin-12-one,
(C) 1 to 150 parts by mass of the at least one filler and reinforcer, and
(E) 0.01 to 2 parts by mass of the at least one heat stabilizer.

10. The polymer composition according to claim 5, wherein the polymer composition comprises, based on 100 parts by mass of the at least one polyamide (A):
(B) 0.01 to 5 parts by mass of the 10,10′-oxybix-12H-phthaloperin-12-one,
(C) 1 to 150 parts by mass of the at least one filler and reinforcer,
(D) 3 to 100 parts by mass of the at least one flame retardant additive, and
(E) 0.01 to 2 parts by mass of the at least one heat stabilizer.

11. The polymer composition according to claim 2, wherein the polymer composition further comprises the component:
(C) 1 to 150 parts by mass of at least one filler and/or reinforcer, based on 100 parts by mass of the at least one polyamide component (A).

12. The polymer composition according to claim 11, wherein the polymer composition further comprises the component:
(D) 3 to 100 parts by mass of at least one flame retardant based on 100 parts by mass of the component A).

13. The polymer composition according to claim 12, wherein the polymer composition further comprises the component:
(E) 0.01 to 80 parts by mass of at least one further additive other than the components (B), (C) and (D), based on 100 parts by mass of component (A).

14. An article which comprises the polymer composition according to claim 1.

15. The article according to claim 14, wherein the article is a high voltage component.

16. A method of making the orange dyed polymer composition according to claim 1, wherein the method comprises:
(a) providing a polymer composition which comprises at least one polyamide component (A), and
(b) blending with the at least one polyamide component (A) of the polymer composition an effective amount of 0.01 to 5 parts by mass per 100 parts by mass of the at least one polyamide component (A) of the 10,10′-oxybis-12H-phthaloperin-12-one dye component (B) sufficient to achieve (i) an orange color corresponding to a color distance ΔE <20 from the L*a*b* coordinates of a color number beginning with “2” in the RAL color chart, and (ii) reduced contact bleeding of the 10,10′-oxybis-12H-phthaloperin-12-one component (B) as compared to a polymer composition having 12H-phthaloperin-12-one as component (B).

17. The method according to claim 16, wherein step (ii) comprises blending with the at least one polyamide component (A) an effective amount of 0.01 to 3 parts by mass of the 10,10′-oxybis-12H-phthaloperin-12 component (B) per 100 parts by mass of the at least one polyamide component (A).

18. The method according to claim 17, wherein the polymer composition further comprises the component:
(C) at least one filler and/or reinforcer.

19. The method according to claim 18, wherein the polymer composition further comprises the component:
(D) at least one flame retardant.

20. The method according to claim 19, wherein the polymer composition further comprises the component:
(E) at least one further additive other than the components (B), (C) and (D).

21. The method according to claim 18, wherein the filler and/or reinforcer component (C) is selected from the group consisting of solid glass beads, hollow glass beads, glass fibers, ground glass, amorphous quartz glass, aluminum borosilicate glass having an alkali content of 1% (E glass), amorphous silica, quartz flour, calcium silicate, calcium metasilicate, magnesium carbonate, kaolin, calcined kaolin, chalk, kyanite, powdered or ground quartz, mica, phlogopite, barium sulfate, feldspar, wollastonite, montmorillonite, pseudoboehmite of the formula AlO(OH), magnesium carbonate and talc.

22. The method according to claim 19, wherein the at least one flame retardant component (D) is selected from mineral flame retardants, nitrogen-containing flame retardants and phosphorus-containing flame retardants.

23. The method according to claim 20, wherein the at least one additive component (E) is at least on heat stabilizer.

24. The method according to claim 20, wherein the polymer composition comprises, based on 100 parts by mass of the at least one polyamide (A):
(B) 0.01 to 5 parts by mass of the 10, 10′-oxybix-12H-phthaloperin-12-one,
(C) 1 to 150 parts by mass of the at least one filler and reinforcer, and
(E) 0.01 to 2 parts by mass of the at least one heat stabilizer.

25. The method according to claim 20, wherein the polymer composition comprises, based on 100 parts by mass of the at least one polyamide (A):
(B) 0.01 to 5 parts by mass of the 10,10′-oxybix-12H-phthaloperin-12-one,
(C) 1 to 150 parts by mass of the at least one filler and reinforcer,
(D) 3 to 100 parts by mass of the at least one flame retardant additive, and
(E) 0.01 to 2 parts by mass of the at least one heat stabilizer.

26. The method according to claim 16, wherein the polymer composition further comprises the component:
(C) 1 to 150 parts by mass of at least one filler and/or reinforcer, based on 100 parts by mass of the at least one polyamide component (A).

27. The method according to claim 26, wherein the polymer composition further comprises the component:
(D) 3 to 100 parts by mass of at least one flame retardant based on 100 parts by mass of the at least one polyamide component (A).

28. The method according to claim 27, wherein the polymer composition further comprises the component:
(E) 0.01 to 80 parts by mass of at least one further additive other than the components (B), (C) and (D), based on 100 parts by mass of component (A).
